(19) United States
(12) Patent Application Publication
(10) Pub. No.: US 2024/0357688 A1
(43) Pub. Date: Oct. 24, 2024

(54) METHOD FOR PERFORMING OPERATION MODE TRANSITION CONTROL IN WIRELESS COMMUNICATION SYSTEM, AND ASSOCIATED APPARATUS

(71) Applicant: MEDIATEK INC., Hsin-Chu (TW)

(72) Inventors: I-Cheng Tsai, Hsinchu City (TW); Chien-Fang Hsu, Hsinchu City (TW)

(73) Assignee: MEDIATEK INC., Hsin-Chu (TW)

(21) Appl. No.: 18/636,302

(22) Filed: Apr. 16, 2024

Related U.S. Application Data
(60) Provisional application No. 63/496,983, filed on Apr. 19, 2023.

(51) Int. Cl. H04W 76/20; H04W 76/10; H04W 88/02

(52) U.S. Cl. CPC H04W 76/20; H04W 76/10; H04W 88/02

(57) ABSTRACT

A method for performing operation mode transition control in a wireless communication system and associated apparatus are provided, where a non-access-point multi-link device (non-AP MLD) is wirelessly linking to a first access point multi-link device (AP MLD). The method includes: transmitting, by the non-AP MLD, a first operation mode notification in a first management frame to the first AP MLD, for a first target operation mode to which the non-AP MLD is going to transit, carrying at least information regarding the first target operation mode, wherein the information is carried in at least one subfield of the first operation mode notification; and transiting, by the non-AP MLD, to the first target operation mode without transmitting additional management information regarding the first target operation mode to the first AP MLD.

### CROSS REFERENCE TO RELATED APPLICATIONS

This application claims the benefit of U.S. Provisional Application No. 63/496,983, filed on Apr. 19, 2023. The content of the application is incorporated herein by reference.

### BACKGROUND

The present invention is related to communication control, and more particularly, to a method for performing operation mode transition control in a wireless communication system, and associated apparatus such as a wireless transceiver device (e.g., an access point (AP) multi-link device (MLD) or a non-access-point (non-AP) MLD) in the wireless communication system.

According to the related art, there may be several multi-link operations (MLOs) that a non-AP MLD can support, such as simultaneous transmit and receive (STR), non-simultaneous transmit and receive (NSTR), multi-link single radio (MLSR) and enhanced multi-link single radio (EMLSR). Among these operations, each operation may have one or more different benefits in one or more different user scenarios, and the non-AP MLD may support multiple operations so that in each scenario, the non-AP MLD can choose an operation to optimize corresponding user experiences such as low-power consumption, maximum throughput, or transmission range. However, the transition between two operations may require multiple steps. This is time-consuming and typically causes unnecessary overhead. For example, if in a user scenario, two operations require frequent transitions, the system performance will become even worse. Thus, a novel method and associated architecture are needed for solving the problems without introducing any side effect or in a way that is less likely to introduce a side effect.

### SUMMARY

It is an objective of the present invention to provide a method for performing operation mode transition control in a wireless communication system, and associated apparatus such as wireless transceiver devices (e.g., an AP MLD and a non-AP MLD) in the wireless communication system, in order to solve the above-mentioned problems.

At least one embodiment of the present invention provides a method for performing operation mode transition control in a wireless communication system, where a non-AP MLD that is capable of supporting any of multiple MLOs may be wirelessly linking to a first AP MLD. The method may comprise: transmit, by the non-AP MLD, a first operation mode notification in a first management frame (or communication frame) to the first AP MLD, for a first target operation mode to which the non-AP MLD is going to transit, carrying at least information regarding the first target operation mode, wherein the information is carried in at least one subfield of the first operation mode notification; and transiting, by the non-AP MLD, to the first target operation mode without transmitting additional management information regarding the first target operation mode to the first AP MLD. For example, the non-AP MLD may be arranged to transit to the first target operation mode in a single step, having no need to perform any multiple-step transition via notifying the first AP MLD with any additional management frame. More particularly, the non-AP MLD may transit to the first target operation mode in the single step rather than multiple steps, without performing the aforementioned any multiple-step transition via notifying the first AP MLD with the aforementioned any additional management frame.

At least one embodiment of the present invention provides a non-AP MLD (e.g., a non-AP station (STA) MLD) for performing operation mode transition control in a wireless communication system such as that mentioned above, where the non-AP MLD may be one of multiple devices within the wireless communication system. The non-AP MLD may comprise a processing circuit that is arranged to control operations of the non-AP MLD. The non-AP MLD may further comprise at least one communication control circuit that is coupled to the processing circuit and arranged to perform communication control, where the aforementioned at least one communication control circuit is arranged to perform wireless communication operations with at least one other device among the multiple devices within the wireless communication system for the non-AP MLD. For example, the aforementioned at least one other device may comprise a first AP MLD, and the non-AP MLD that is capable of supporting any of multiple MLOs may be wirelessly linking to the first AP MLD. In addition, the non-AP MLD may be arranged to transmit a first operation mode notification in a first management frame to the first AP MLD, for a first target operation mode to which the non-AP MLD is going to transit, carrying at least information regarding the first target operation mode, wherein the information is carried in at least one subfield of the first operation mode notification; and the non-AP MLD may be arranged to transit to the first target operation mode without transmitting any additional management information regarding the first target operation mode to the first AP MLD.

According to some embodiments, the present invention also provides an AP MLD for performing operation mode transition control in a wireless communication system such as that mentioned above, where the AP MLD may be one of multiple devices within the wireless communication system. The AP MLD may comprise a processing circuit that is arranged to control operations of the AP MLD. The AP MLD may further comprise at least one communication control circuit that is coupled to the processing circuit and arranged to perform communication control, where the aforementioned at least one communication control circuit is arranged to perform wireless communication operations with at least one other device among the multiple devices within the wireless communication system for the AP MLD. For example, the aforementioned at least one other device may comprise a non-AP MLD, and the non-AP MLD that is capable of supporting any of multiple MLOs may be wirelessly linking to the AP MLD. In addition, the AP MLD may be arranged to receive a first management frame carrying a first operation mode notification from the non-AP MLD, the first operation mode notification for a first target operation mode to which the non-AP MLD is going to transit, as well as information regarding the first target operation mode, wherein the information is carried in at least one subfield of the first operation mode notification; and the AP MLD may be arranged to selectively respond to or skip responding to the first operation mode notification, to allow the non-AP MLD to transit to the first target operation mode without receiving any additional management information regarding the first target operation mode from the non-AP MLD.

It is an advantage of the present invention that, through proper design, the present invention method, as well as the associated apparatus such as the wireless transceiver devices (e.g., the AP MLD and the non-AP MLD) in the wireless communication system, can simplify the transition with a novel and efficient protocol, to enhance the overall performance. For example, if in a certain user scenario, two operations require frequent transitions, the wireless transceiver devices (e.g., the AP MLD and the non-AP MLD) can operate in an efficient manner, and more particularly, perform the operation mode transitions in a single step, having no need to spend precious time on multiple-step transition. In addition, the method and apparatus of the present invention can solve the related art problems without introducing any side effect or in a way that is less likely to introduce a side effect.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of a wireless communication system according to an embodiment of the present invention.

FIG. 2 illustrates, in the right half part thereof, a single-step transition control scheme of a method for performing operation mode transition control in a wireless communication system according to an embodiment of the present invention, where a multi-step transition control scheme may be illustrated in the left half part of FIG. 2 for better comprehension.

FIG. 3 illustrates a Mode Control IE format according to an embodiment of the present invention.

FIG. 4 illustrates a working flow of the method according to an embodiment of the present invention.

### DETAILED DESCRIPTION

Certain terms are used throughout the following description and claims, which refer to particular components. As one skilled in the art will appreciate, electronic equipment manufacturers may refer to a component by different names. This document does not intend to distinguish between components that differ in name but not in function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

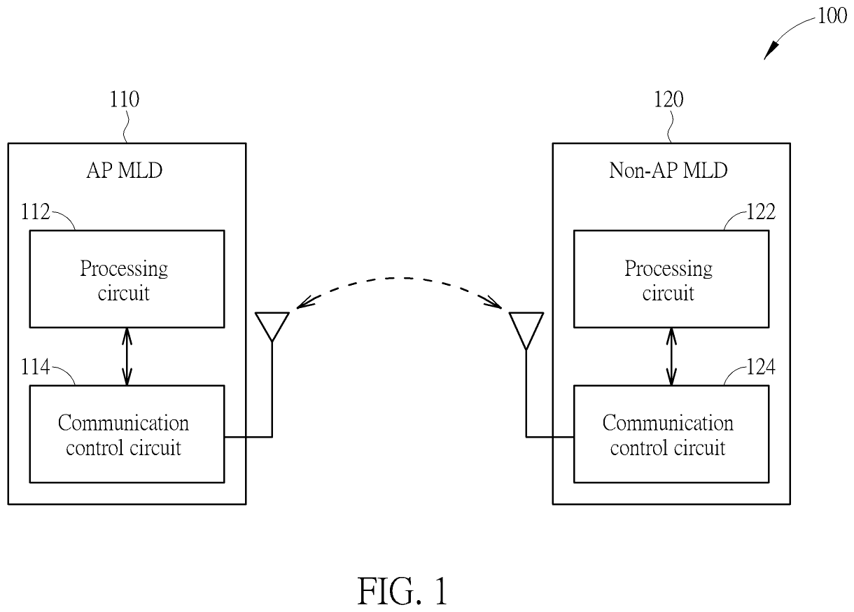

FIG. 1 is a diagram of a wireless communication system 100 according to an embodiment of the present invention. For better comprehension, the wireless communication system 100, as well as any wireless transceiver device #n among multiple wireless transceiver devices #1, . . . and #N therein, may be compatible or backward-compatible to one or more versions of the Institute of Electrical and Electronics Engineers (IEEE) 802.11 standards, but the present invention is not limited thereto. Regarding the multiple wireless transceiver devices #1, . . . and #N within the wireless communication system 100, a wireless transceiver device among them may be implemented as an AP MLD 110, and another transceiver device among them may be implemented as a non-AP MLD 120, but the present invention is not limited thereto. For example, two or more wireless transceiver devices among the multiple wireless transceiver devices #1, . . . and #N may be implemented as multiple AP MLDs {110}. For another example, two or more wireless transceiver devices among the multiple wireless transceiver devices #1, . . . and #N may be implemented as multiple non-AP MLDs {120}. In some examples, two or more wireless transceiver devices among the multiple wireless transceiver devices #1, . . . and #N may be implemented as multiple AP MLDs {110}, and two or more other wireless transceiver devices among the multiple wireless transceiver devices #1, . . . and #N may be implemented as multiple non-AP MLDs {120}.

As shown in FIG. 1, the AP MLD 110 may comprise a processing circuit 112, at least one communication control circuit (e.g., one or more communication control circuits), which may be collectively referred to as the communication control circuit 114, and at least one antenna (e.g., one or more antennas) of the communication control circuit 114, and the non-AP MLD 120 may comprise a processing circuit 122, at least one communication control circuit (e.g., one or more communication control circuits), which may be collectively referred to as the communication control circuit 124, and at least one antenna (e.g., one or more antennas) of the communication control circuit 124. In the architecture shown in FIG. 1, the processing circuit 112 can be arranged to control operations of the AP MLD 110, and the communication control circuit 114 can be arranged to perform communication control, and more particularly, perform wireless communication operations with the network (or at least one other device therein such as the non-AP MLD 120) for the AP MLD 110. In addition, the processing circuit 122 can be arranged to control operations of the non-AP MLD 120, and the communication control circuit 124 can be arranged to perform communication control, and more particularly, perform wireless communication operations with the network (or at least one other device therein such as the AP MLD 110) for the non-AP MLD 120.

According to some embodiments, the processing circuit 112 can be implemented by way of at least one processor/microprocessor, at least one random access memory (RAM), at least one bus, etc., and the communication control circuit 114 can be implemented by way of at least one wireless network control circuit and at least one wired network control circuit, but the present invention is not limited thereto. Examples of the AP MLD 110 may include, but are not limited to: a Wi-Fi router. In addition, the processing circuit 122 can be implemented by way of at least one processor/microprocessor, at least one RAM, at least one bus, etc., and the communication control circuit 124 can be implemented by way of at least one wireless network control circuit, but the present invention is not limited thereto. Examples of the non-AP MLD 120 may include, but are not limited to: a multifunctional mobile phone, a laptop computer, an all-in-one computer and a wearable device.

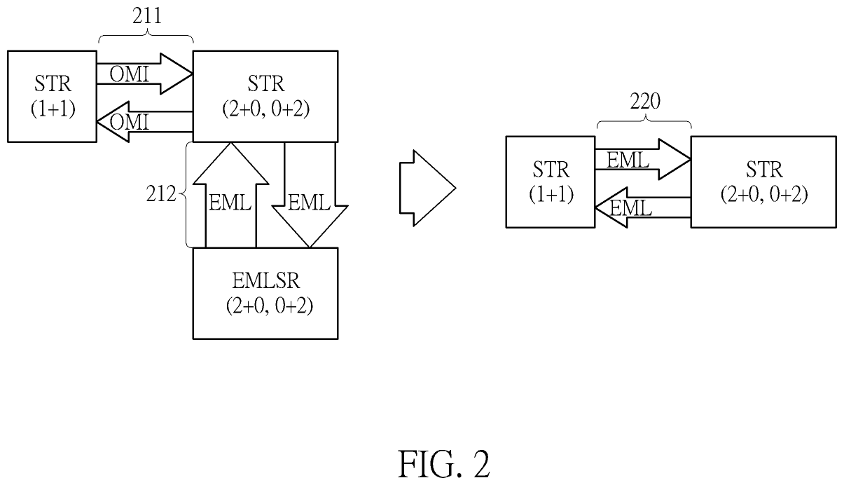

FIG. 2 illustrates, in the right half part thereof, a single-step transition control scheme of a method for performing operation mode transition control in a wireless communication system according to an embodiment of the present invention, where a multi-step transition control scheme may be illustrated in the left half part of FIG. 2 for better comprehension. The non-AP MLD 120 may be capable of supporting any of multiple MLOs, and may be wirelessly linking to the AP MLD 110, and the associated operations of the method may comprise:
(1) the non-AP MLD 120 may carry a first operation mode notification in a first management frame from the non-AP MLD 120 to the AP MLD 110, for indicating a first target operation mode to which the non-AP MLD 120 is going to transit, as well as necessary information regarding the first target operation mode, where the necessary information may be carried in at least one subfield of the first operation mode notification; and
(2) the non-AP MLD 120 may transit to the first target operation mode in a single step, having no need to perform any multiple-step transition via notifying the AP MLD 110 with any additional management frame, where the non-AP MLD 120 may transit to the first target operation mode in the single step rather than multiple steps, without performing the aforementioned any multiple-step transition via notifying the AP MLD 110 with the aforementioned any additional management frame;
where the first management frame may be implemented as one or a combination of an enhanced multi-link (EML) operation mode notification (OMN) frame and a Unified Operation Mode Notification frame format, conforming to a predetermined frame format, but the present invention is not limited thereto. For example, the predetermined frame format may represent a Protected EML Operating Mode Notification frame Action field format, and the aforementioned at least one subfield may comprise a Mode Control subfield in the Protected EML Operating Mode Notification frame Action field format. In another example, the predetermined frame format may represent a first predetermined frame format (e.g., a Frame Format #1), and the aforementioned at least one subfield may comprise a first mode-dedicated parameter subfield corresponding to the first target operation mode, such as a pre-selected mode-dedicated parameter subfield that is selected from multiple predetermined mode-dedicated parameter subfields in the first predetermined frame format. In some examples, the predetermined frame format may represent a second predetermined frame format (e.g., a Frame Format #2) carrying a Mode Control information element (IE), with the multiple predetermined mode-dedicated parameter subfields being integrated into the Mode Control IE, and the aforementioned at least one subfield may comprise the first mode-dedicated parameter subfield corresponding to the first target operation mode, such as a pre-selected mode-dedicated parameter subfield that is selected from the multiple predetermined mode-dedicated parameter subfields in the Mode Control IE. No matter whether the predetermined frame format represents the Protected EML Operating Mode Notification frame Action field format or any other frame format such as any of the first predetermined frame format and the second predetermined frame format, the existence of the aforementioned at least one subfield in the predetermined frame format may be arranged to indicate a request for transiting to the first target operation mode by the non-AP MLD 120. In addition, the necessary information may comprise one or a combination of maximum number of spatial streams (NSS) information regarding at least one predetermined radio frequency (RF) band, at least one updated parameter that is updated for operating in the first target operation mode, at least one common parameter (e.g., at least one MLD level parameter) for operating in the first target operation mode and at least one per-link parameter for operating in the first target operation mode. For example, the aforementioned at least one predetermined RF band may comprise multiple predetermined RF bands, the NSS information may comprise the respective NSS {N_{SS}} of the multiple predetermined RF bands, and the aforementioned at least one updated parameter may comprise a Maximum Number Of Simultaneous Links, etc.

Assume that one or more functions of the wireless communication system 100 may be temporarily disabled to allow the AP MLD 110 and the non-AP MLD 120 to operate according to the multi-step transition control scheme shown in the left half part of FIG. 2, and the operation mode transition may comprise the transitions between multiple operation modes, such as the transitions regarding the STR mode to/from the EMLSR mode, but the present invention is not limited thereto. Based on the multi-step transition control scheme, for the non-AP MLD 120 which may be operating in the STR mode after association and may need to transit to operate in the EMLSR mode, two steps 211 and 212 are typically required. For example, the non-AP MLD 120 may be capable of receiving (RX) or transmitting (TX) with two spatial stream (SS) and capable of supporting two bands #1 and #2 (or “the band 1” and “the band 2”) among the multiple predetermined RF bands. During the association, in order to operate in the STR mode, the non-AP MLD 120 may announce its NSS operation mode as 1SS on the band #1 and 1SS on the band #2, noted as 1+1. In order to operate in the EMLSR mode, the non-AP MLD 120 may have to first use the operating mode (OM) indication (OMI) protocol (or the OMIs thereof) to inform the AP MLD 110 that the non-AP MLD 120 is capable of operate with 2SS on either band among the two bands #1 and #2, noted as 2+0 and 0+2 depending on the operation on the band #1 or the band #2. Then the non-AP MLD 120 may use an EML OMN (or EMLSR mode notification) frame (labeled “EML” for brevity) to notice the AP MLD 110 that the non-AP MLD 120 intends to switch to operate in the EMLSR mode. After a timeout or the AP MLD's response with another EML OMN frame, the non-AP MLD 120 can operate in the EMLSR mode. If the non-AP MLD 120 needs to transit from the EMLSR mode back to the STR mode, a two-step reverse procedure is also needed, where the two-step reverse procedure may comprise the EML OMN frame exchange to transit to the STR mode and using the OMI protocol to complete the OM change notification. As multiple steps 211 and 212 are required for any transition among the transition from the STR mode to the EMLSR mode and the transition from the EMLSR mode to the STR mode, when it is needed to frequently transit between the two modes, the performance degradation may reach an intolerable level.

As shown in the right half part of FIG. 2, the wireless communication system 100 (or the AP MLD 110 and the non-AP MLD 120 therein) may operate according to the single-step transition control scheme to achieve a better overall performance, and more particularly, reuse the current EML OMN frame's contents and add at least one Mode Control subfield to the EML OMN frame, in order to complete the mode transition in a one-step protocol (or “the 1-step protocol”). For example, regarding the transition from the STR mode to the EMLSR mode, the non-AP MLD 120 may carry the first operation mode notification in the first management frame (e.g., a first EML OMN frame, labeled “EML” for brevity) from the non-AP MLD 120 to the AP MLD 110, for indicating the first target operation mode (e.g., the EMLSR mode) to which the non-AP MLD 120 is going to transit, as well as the necessary information regarding the first target operation mode, and may transit to the first target operation mode (e.g., the EMLSR mode) in the single step such as one step 220, rather than the multiple steps such as the two steps 211 and 212, where the necessary information may be carried in the aforementioned at least one subfield (e.g., the aforementioned at least one Mode Control subfield) of the first operation mode notification within the first management frame (e.g., the first EML OMN frame). In another example, regarding the transition from the EMLSR mode to the STR mode, the non-AP MLD 120 may carry the first operation mode notification in the first management frame (e.g., another first EML OMN frame, labeled “EML” for brevity) from the non-AP MLD 120 to the AP MLD 110, for indicating the first target operation mode (e.g., the STR mode) to which the non-AP MLD 120 is going to transit, as well as the necessary information regarding the first target operation mode, and may transit to the first target operation mode (e.g., the STR mode) in the single step such as one step 220, rather than the multiple steps such as the two steps 211 and 212, where the necessary information may be carried in the aforementioned at least one subfield (e.g., the aforementioned at least one Mode Control subfield) of the first operation mode notification within the first management frame (e.g., the other first EML OMN frame). Therefore, the non-AP MLD 120 can perform the operation mode transition in the single step such as one step 220, having no need to perform any multiple-step transition via notifying the AP MLD 110 with the aforementioned any additional management frame.

TABLE 1

| Order | Information |
|---|---|
| 1 | Category |
| 2 | Protected EHT Action |
| 3 | Dialog Token |
| 4 | EML Control |
| 5 | EMLSR Parameter Update (optional) |
| 6 | Mode Control subfield(s) (optional) |

Table 1 illustrates an example of the Protected EML Operating Mode Notification frame Action field format, where the format shown in Table 1 may comprise the Category, the Protected EHT Action, the Dialog Token, the EML Control field, the EMLSR Parameter Update field and the Mode Control subfield(s) in Order 1 to Order 6, respectively. The Mode Control subfield(s) may also be referred to as the Mode Control field(s). The Mode Control field can carry the complete or partial NSS information to be operating after the mode transition. For example, the NSS information may be combined with other NSS information, such as the NSS in the A-Control field to indicate the complete NSS to operate after the transition. In addition, the Mode Control field can carry parameters which can be different while the non-AP MLD 120 is operating in the STR or the EMLSR modes, for example, the parameters may comprise the Maximum Number Of Simultaneous Links. Additionally, the Mode Control field can carry Link Identifier (ID) information to indicate which link the Mode Control's contents to be applied to. For example, the Mode Control field can carry additional power saving (PS) mode indication (other than the one in the medium access control (MAC) header) after the transition. While the PS mode indication is carried for a link indicated by the Link ID, the non-AP MLD 120 does not need to send any additional PS mode notification to the AP MLD 110 over the link. For example, there could be multiple Mode Control subfields specifying different parameters for different links by Link ID indications, respectively. While using the EMN OMN frame to notice the exit of the EMLSR mode, the mode to operate can also be indicated in the Mode Control field, for example, with the indication for the STR mode or the indication for the MLSR mode.

Based on at least one control scheme (e.g., the single-step transition control scheme and one or more other control schemes) of the method, the non-AP MLD 120 may be arranged to carry the Link ID information in the aforementioned at least one subfield, for indicating which link the necessary information is applied to. The necessary information may comprise multiple per-link parameters that are specified at multiple subfields for different links by Link ID indications, respectively, where the aforementioned at least one subfield may comprise the multiple subfields. For example, the first management frame may be implemented as the EML OMN frame conforming to the Protected EML Operating Mode Notification frame Action field format, and the aforementioned at least one subfield may comprise the Mode Control subfield in the Protected EML Operating Mode Notification frame Action field format, and more particularly, the Link ID information may be carried in the Mode Control subfield, but the present invention is not limited thereto. According to some embodiments, the non-AP MLD 120 may be arranged to aggregate an MLO Link Information element in the first management frame, and the Link ID information may be carried in the MLO Link Information element rather than the Mode Control subfield. In this case, a physical layer (PHY) protocol data unit (PPDU) may carry multiple EML OMN frames, with each one among the multiple EML OMN frames carrying the parameters to be applied on the corresponding link. For example, the MLD level or common parameters of all links are the same for all EML OMN frames. In addition, the non-AP MLD 120 may be arranged to carry the PS mode indication in the aforementioned at least one subfield, for indicating the PS mode (e.g., the PS mode of a first link on which the first management frame is not transmitting) after transiting to the first target operation mode, having no need to carry any other PS mode indication in any MAC header of any MAC protocol data unit (MPDU) within any PPDU. Additionally, the non-AP MLD 120 may be arranged to use a second management frame from the non-AP MLD 120 to the AP MLD 110 to notify the AP MLD 110 of the exit of the first target operation mode and/or a request for transiting to a different target operation mode. For example, the non-AP MLD 120 may carry a second operation mode notification in the second management frame from the non-AP MLD 120 to the AP MLD 110, for indicating a second target operation mode to which the non-AP MLD 120 is going to transit, as well as necessary information regarding the second target operation mode, and may transit to the second target operation mode in a single step, having no need to perform any multiple-step transition via notifying the AP MLD 110 with any additional management frame, where the necessary information regarding the second target operation mode may be carried in at least one subfield of the second operation mode notification.

TABLE 2

| Order | Information |
|---|---|
| 1 | Category |
| 2 | Protected UHR Action |
| 3 | Dialog Token |
| 4 | Target mode subfield |
| 5 | MLSR parameter subfield |
| 6 | STR parameter subfield |
| 7 | EMLSR parameter subfield |
| 8 | NSTR parameter subfield |

Table 2 illustrates an example of the Unified Operation Mode Notification frame format according to a non-IE-based operation mode notification control scheme of the method, where the aforementioned first predetermined frame format such as the Frame Format #1 (or “the Frame Format 1”) may be implemented as the frame format shown in Table 2, and more particularly, may comprise the Category, the Protected UHR Action, the Dialog Token, the Target mode subfield, the MLSR parameter subfield, the STR parameter subfield, the EMLSR parameter subfield and the NSTR parameter subfield in Order 1 to Order 8, respectively. The non-IE-based operation mode notification control scheme may define the Unified Operation Mode Notification frame to indicate the target mode to transit, such as the first target operation mode, and the relevant parameters to update. More particularly, the target mode subfield may be arranged to indicate the mode to operate after successful frame exchange, and it can be any mode among multiple candidate modes such as the STR mode, the MLSR mode, the EMLSR mode and the NSTR mode, but the present invention is not limited thereto. According to some embodiments, assuming that the multiple candidate modes comprise one or more additional modes, the aforementioned first predetermined frame format such as the Frame Format #1 (or “the Frame Format 1”) may comprise one or more subsequent parameter subfields corresponding to the one or more additional modes in Orders 9, etc., and the aforementioned mode to operate can be any mode among the STR mode, the MLSR mode, the EMLSR mode, the NSTR mode and so on.

In addition, any mode-dedicated parameter subfield among all mode-dedicated parameter subfields in the aforementioned first predetermined frame format such as the Frame Format #1 may be arranged to carry the necessary information such as the necessary parameters to update while operating on the corresponding mode (or the mode to which the aforementioned any mode-dedicated parameter subfield corresponds). In a situation where the Target mode subfield indicates the aforementioned mode to operate, a certain mode-dedicated parameter subfield among all mode-dedicated parameter subfields in the aforementioned first predetermined frame format such as the Frame Format #1 may be arranged to carry the necessary information such as the necessary parameters to update while operating on that mode. More particularly, the necessary information such as these necessary parameters may comprise both link level and MLD level parameters, including at least one link level parameter (e.g., one or more link level parameters) and at least one MLD level parameter (e.g., one or more MLD level parameters). For example, the aforementioned at least one MLD level parameter may comprise the NSS (N_{SS}) for the STR operation on each link and the Maximum Number Of Simultaneous Links of the non-AP MLD 120, and the aforementioned at least one link level parameter may comprise the Link ID information. For the link level parameters, at least the Link ID information needs to be carried in this mode-dedicated parameter subfield to indicate the link which the parameters to be applied to.

Based on at least one control scheme (e.g., the single-step transition control scheme, the non-IE-based operation mode notification control scheme and one or more other control schemes) of the method, the necessary information may comprise the aforementioned at least one updated parameter that is updated for operating in the first target operation mode, and the aforementioned at least one updated parameter may comprise both the link level and MLD level parameters, including the aforementioned at least one link level parameter and the aforementioned at least one MLD level parameter. For example, the first management frame may be implemented as the Unified Operation Mode Notification frame conforming to the first predetermined frame format (e.g., the Frame Format #1), and the aforementioned at least one subfield may comprise a first mode-dedicated parameter subfield corresponding to the first target operation mode among multiple predetermined mode-dedicated parameter subfields in the first predetermined frame format, but the present invention is not limited thereto. According to some embodiments, the first management frame may be implemented as the Unified Operation Mode Notification frame conforming to the second predetermined frame format (e.g., the Frame Format #2) carrying the Mode Control IE, and the aforementioned at least one subfield may comprise the first mode-dedicated parameter subfield corresponding to the first target operation mode among the multiple predetermined mode-dedicated parameter subfields in the Mode Control IE.

TABLE 3

| Order | Information |
|---|---|
| 1 | Category |
| 2 | Protected UHR Action |
| 3 | Dialog Token |
| 4 | Mode Control IE(s) |

Table 3 illustrates an example of the Unified Operation Mode Notification frame format according to an IE-based operation mode notification control scheme of the method, where the aforementioned second predetermined frame format such as the Frame Format #2 (or “the Frame Format 2”) may be implemented as the frame format shown in Table 3, and more particularly, may comprise the Category, the Protected UHR Action, the Dialog Token and the Mode Control IE(s) in Order 1 to Order 4, respectively. Instead of using individual subfield, those subfields mentioned in the non-IE-based operation mode notification control scheme, such as the Target mode subfield and all mode-dedicated parameter subfields, can be integrated as an information element (IE) such as the Mode Control IE. For example, any mode-dedicated parameter subfield (e.g., the first mode-dedicated parameter subfield corresponding to the first target operation mode) among the multiple predetermined mode-dedicated parameter subfields in the Mode Control IE may comprise a Common Parameters subfield and at least one Per Link Parameters subfield. More particularly, the aforementioned at least one Per Link Parameters subfield may comprise multiple Per Link Parameters subfields. Among the multiple Per Link Parameters subfields, any Per Link Parameters subfield with a Link ID can be carried in the aforementioned any mode-dedicated parameter subfield to indicate per link parameters to be applied, but the present invention is not limited thereto. In some examples, if no Per Link Parameters subfield or no Link ID is carried in the aforementioned any mode-dedicated parameter subfield, the IE such as the Mode Control IE can work together with an MLO Link Information element to indicate which link the IE's contents to be applied to.

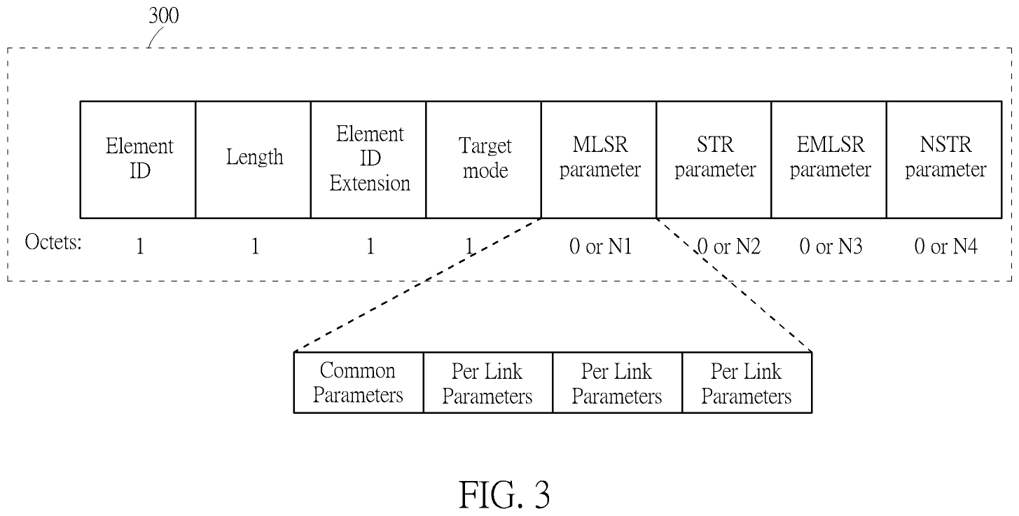

FIG. 3 illustrates a Mode Control IE format 300 according to an embodiment of the present invention, where the Mode Control IE format 300 can be taken as an example of the Mode control IE(s) shown in Table 3. The Mode Control IE format 300 may comprise multiple fields such as the Element ID field, the Length field, the Element ID Extension field, and the aforementioned Target mode subfield and the multiple predetermined mode-dedicated parameter subfields (e.g., the MLSR parameter subfield, the STR parameter subfield, the EMLSR parameter subfield and the NSTR parameter subfield) that are integrated into the Mode Control IE, which may be measured in unit of octets (or bytes). In the Mode Control IE format 300, the multiple predetermined mode-dedicated parameter subfields may have the length being selected from multiple candidate lengths thereof such as the candidate lengths {0, N1}, {0, N2}, {0, N3} and {0, N4}, respectively, and “N1”, “N2”, “N3” and “N4” may be positive integers. In a first example, the aforementioned any mode-dedicated parameter subfield such as the first mode-dedicated parameter subfield corresponding to the first target operation mode may represent the MLSR parameter subfield corresponding to the MLSR mode, and the MLSR parameter subfield may have the length of N1 rather than zero and may be illustrated to carry the Common Parameters subfield and the aforementioned at least one Per Link Parameters subfield such as the Per Link Parameters subfields shown in FIG. 3, but the present invention is not limited thereto. In a second example, the aforementioned any mode-dedicated parameter subfield such as the first mode-dedicated parameter subfield corresponding to the first target operation mode may represent the STR parameter subfield corresponding to the STR mode, and the STR parameter subfield may have the length of N2 rather than zero and may be illustrated to carry the Common Parameters subfield and the aforementioned at least one Per Link Parameters subfield such as the Per Link Parameters subfields shown in FIG. 3. In a third example, the aforementioned any mode-dedicated parameter subfield such as the first mode-dedicated parameter subfield corresponding to the first target operation mode may represent the EMLSR parameter subfield corresponding to the EMLSR mode, and the EMLSR parameter subfield may have the length of N3 rather than zero and may be illustrated to carry the Common Parameters subfield and the aforementioned at least one Per Link Parameters subfield such as the Per Link Parameters subfields shown in FIG. 3. In a fourth example, the aforementioned any mode-dedicated parameter subfield such as the first mode-dedicated parameter subfield corresponding to the first target operation mode may represent the NSTR parameter subfield corresponding to the NSTR mode, and the NSTR parameter subfield may have the length of N4 rather than zero and may be illustrated to carry the Common Parameters subfield and the aforementioned at least one Per Link Parameters subfield such as the Per Link Parameters subfields shown in FIG. 3.

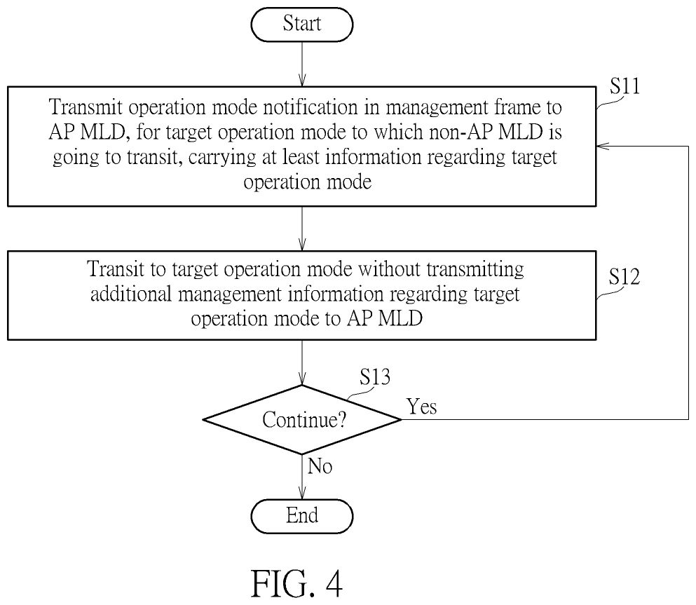

FIG. 4 illustrates a working flow of the method according to an embodiment of the present invention, where the method may be applied to the aforementioned any wireless transceiver device within the wireless communications system 100 shown in FIG. 1, such as any MLD among the AP MLD 110 and the non-AP MLD 120.

In Step S11, the non-AP MLD 120 may transmit an operation mode notification (e.g., the first operation mode notification) in a management frame (e.g., the first management frame) to the AP MLD 110, for a target operation mode (e.g., the first target operation mode) to which the non-AP MLD 120 is going to transit, carrying at least the necessary information regarding the target operation mode, where the necessary information may be carried in at least one subfield of the operation mode notification. For example, the non-AP MLD 120 may send the management frame (e.g., the first management frame) carrying the operation mode notification (e.g., the first operation mode notification) to the AP MLD 110, for indicating the target operation mode (e.g., the first target operation mode) to which the non-AP MLD 120 is going to transit, as well as the necessary information regarding the target operation mode.

In Step S12, the non-AP MLD 120 may transit to the target operation mode (e.g., the first target operation mode) without transmitting any additional management information regarding the target operation mode (e.g., the first target operation mode) to the AP MLD 110. For example, the non-AP MLD 120 may transit to the target operation mode (e.g., the first target operation mode) in a single step, having no need to perform any multiple-step transition via notifying the AP MLD 110 with any additional management frame. More particularly, the non-AP MLD 120 may transit to the target operation mode in the single step rather than multiple steps, without performing the aforementioned any multiple-step transition via notifying the AP MLD 110 with the aforementioned any additional management frame.

In Step S13, the non-AP MLD 120 may determine whether to continue with the loop shown in FIG. 4. If Yes, Step S11 is entered; if No, the working flow shown in FIG. 4 comes to the end. More particularly, if no further operation mode transition is needed, for example, when no communication between the non-AP MLD 120 and the AP MLD 110 is needed, the non-AP MLD 120 may determine to leave the loop and therefore stop executing the working flow shown in FIG. 4; otherwise, the non-AP MLD 120 may determine to continue with the loop and therefore execute Step S11.

For example, after the operation of Step S11, the AP MLD 110 may receive the management frame (e.g., the first management frame) carrying the operation mode notification (e.g., the first operation mode notification) from the non-AP MLD 120, the operation mode notification for the target operation mode (e.g., the first target operation mode) to which the non-AP MLD 120 is going to transit, as well as the necessary information regarding the target operation mode, where the necessary information may be carried in the aforementioned at least one subfield of the operation mode notification. In addition, the AP MLD 110 may selectively respond to or skip responding to the operation mode notification (e.g., the first operation mode notification), to allow the non-AP MLD 120 to transit to the target operation mode (e.g., the first target operation mode) without receiving the aforementioned any additional management information regarding the target operation mode (e.g., the first target operation mode) from the non-AP MLD 120. For example, the non-AP MLD 120 may transit in the single step in Step S12, having no need to perform the aforementioned any multiple-step transition via notifying the AP MLD 110 with the aforementioned any additional management frame. For brevity, similar descriptions for this embodiment are not repeated in detail here.

For better comprehension, the method may be illustrated with the working flow shown in FIG. 4, but the present invention is not limited thereto. According to some embodiments, one or more steps may be added, deleted, or changed in the working flow shown in FIG. 4. For example, the non-AP MLD 120 may use another management frame (e.g., the second management frame) from the non-AP MLD 120 to the AP MLD 110 to notify the AP MLD 110 of the request for transiting to a next target operation mode that is different from the current target operation mode (e.g., the first target operation mode), and more particularly, may transmit a next operation mode notification (e.g., the second operation mode notification) in the other management frame (e.g., the second management frame) to the AP MLD 110, for the next target operation mode (e.g., the second target operation mode) to which the non-AP MLD 120 is going to transit, carrying at least the necessary information regarding the next target operation mode, where the necessary information regarding the next target operation mode may be carried in at least one subfield of the next operation mode notification. In addition, the non-AP MLD 120 may transit to the next target operation mode without transmitting any additional management information regarding the next target operation mode to the AP MLD 110. For example, the non-AP MLD 120 may transit to the next target operation mode (e.g., the second target operation mode) in a single step, having no need to perform any multiple-step transition via notifying the AP MLD 110 with any additional management frame. For brevity, similar descriptions for these embodiments are not repeated in detail here.

According to some embodiments, the multiple predetermined RF bands may comprise the 2.4 gigahertz (GHz) band, the 5 GHz band and the 6 GHz band, but the present invention is not limited thereto. According to some embodiments, the multiple predetermined RF bands may vary.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for performing operation mode transition control in a wireless communication system, wherein a non-access-point multi-link device (non-AP MLD) is wirelessly linking to a first access point multi-link device (AP MLD), the method comprising:
transmitting, by the non-AP MLD, a first operation mode notification in a first management frame to the first AP MLD, for a first target operation mode to which the non-AP MLD is going to transit, carrying at least information regarding the first target operation mode, wherein the information is carried in at least one subfield of the first operation mode notification; and
transiting, by the non-AP MLD, to the first target operation mode without transmitting additional management information regarding the first target operation mode to the first AP MLD.

2. The method of claim 1, wherein the first management frame is implemented as one or a combination of an enhanced multi-link (EML) operation mode notification (OMN) frame and a unified operation mode notification frame, conforming to a predetermined frame format.

3. The method of claim 2, wherein the predetermined frame format represents a protected EML operating mode notification frame action field format, and the at least one subfield comprises a mode control subfield in the protected EML operating mode notification frame action field format.

4. The method of claim 2, wherein the predetermined frame format represents a first predetermined frame format, and the at least one subfield comprises a first mode-dedicated parameter subfield corresponding to the first target operation mode.

5. The method of claim 2, wherein the predetermined frame format represents a second predetermined frame format carrying a mode control information element (IE), and the at least one subfield comprises a first mode-dedicated parameter subfield corresponding to the first target operation mode.

6. The method of claim 2, wherein existence of the at least one subfield in the predetermined frame format is arranged to indicate a request for transiting to the first target operation mode by the non-AP MLD.

7. The method of claim 1, wherein the information comprises one or a combination of maximum number of spatial streams (NSS) information regarding at least one predetermined radio frequency band, at least one updated parameter that is updated for operating in the first target operation mode, at least one MLD level parameter for operating in the first target operation mode and at least one per-link parameter for operating in the first target operation mode.

8. The method of claim 7, wherein the at least one updated parameter comprises a maximum number of simultaneous links.

9. The method of claim 1, wherein the non-AP MLD is arranged to carry link identifier (ID) information in the at least one subfield, for indicating which link the information is applied to.

10. The method of claim 9, wherein the information comprises multiple per-link parameters that are specified at multiple subfields for different links by link ID indications, respectively, wherein the at least one subfield comprises the multiple subfields.

11. The method of claim 9, wherein the first management frame is implemented as an enhanced multi-link (EML) operation mode notification (OMN) frame conforming to a protected EML operating mode notification frame action field format, and the at least one subfield comprises a mode control subfield in the protected EML operating mode notification frame action field format; and the link ID information is carried in the mode control subfield.

12. The method of claim 9, wherein the first management frame is implemented as an enhanced multi-link (EML) operation mode notification (OMN) frame conforming to a protected EML operating mode notification frame action field format, and the at least one subfield comprises a mode control subfield in the protected EML operating mode notification frame action field format; and the non-AP MLD is arranged to aggregate a multi-link operation (MLO) link information element in the first management frame, wherein the link ID information is carried in the MLO link information element rather than the mode control subfield.

13. The method of claim 1, wherein the non-AP MLD is arranged to carry power saving (PS) mode indication in the at least one subfield, for indicating a PS mode of a first link on which the first management frame is not transmitting after transiting to the first target operation mode.

14. The method of claim 1, wherein the information comprises at least one updated parameter that is updated for operating in the first target operation mode, and the at least one updated parameter comprises both link level and MLD level parameters, including at least one link level parameter and at least one MLD level parameter.

15. The method of claim 14, wherein the first management frame is implemented as a unified operation mode notification frame conforming to a first predetermined frame format, and the at least one subfield comprises a first mode-dedicated parameter subfield corresponding to the first target operation mode among multiple predetermined mode-dedicated parameter subfields in the first predetermined frame format.

16. The method of claim 14, wherein the first management frame is implemented as a unified operation mode notification frame conforming to a second predetermined frame format carrying a mode control information element (IE), and the at least one subfield comprises a first mode-dedicated parameter subfield corresponding to the first target operation mode among multiple predetermined mode-dedicated parameter subfields in the mode control IE.

17. A non-access-point multi-link device (non-AP MLD), for performing operation mode transition control in a wireless communication system, the non-AP MLD comprising:
a processing circuit, arranged to control operations of the non-AP MLD; and
at least one communication control circuit, coupled to the processing circuit, arranged to perform communication control, wherein the at least one communication control circuit is arranged to perform wireless communication operations with at least one other device within the wireless communication system for the non-AP MLD, wherein the at least one other device comprises a first access point multi-link device (AP MLD), and the non-AP MLD is wirelessly linking to the first AP MLD;
wherein:
the non-AP MLD is arranged to transmit a first operation mode notification in a first management frame to the first AP MLD, for a first target operation mode to which the non-AP MLD is going to transit, carrying at least information regarding the first target operation mode, wherein the information is carried in at least one subfield of the first operation mode notification; and
the non-AP MLD is arranged to transit to the first target operation mode without transmitting additional management information regarding the first target operation mode to the first AP MLD.

18. An access point multi-link device (AP MLD), for performing operation mode transition control in a wireless communication system, the AP MLD comprising:
a processing circuit, arranged to control operations of the AP MLD; and
at least one communication control circuit, coupled to the processing circuit, arranged to perform communication control, wherein the at least one communication control circuit is arranged to perform wireless communication operations with at least one other device within the wireless communication system for the AP MLD, wherein the at least one other device comprises a non-access-point multi-link device (non-AP MLD), and the non-AP MLD is wirelessly linking to the AP MLD;
wherein:
the AP MLD is arranged to receive a first management frame carrying a first operation mode notification from the non-AP MLD, the first operation mode notification for a first target operation mode to which the non-AP MLD is going to transit, as well as information regarding the first target operation mode, wherein the information is carried in at least one subfield of the first operation mode notification; and
the AP MLD is arranged to selectively respond to or skip responding to the first operation mode notification, to allow the non-AP MLD to transit to the first target operation mode without receiving any additional management information regarding the first target operation mode from the non-AP MLD.
